(19) United States
(12) Patent Application Publication
(10) Pub. No.: US 2020/0050772 A1
(43) Pub. Date: Feb. 13, 2020

(54) SYSTEMS AND METHODS FOR COMPOSITE CODE GENERATION FOR HIGH SECURITY TRANSACTIONS AND DOCUMENT TRACKING

(71) Applicant: JPMORGAN CHASE Bank, N.A., New York, NY (US)

(72) Inventor: Eren KURSUN, New York, NY (US)

(73) Assignee: JPMORGAN CHASE Bank, N.A., New York, NY (US)

(21) Appl. No.: 14/203,262

(22) Filed: Mar. 10, 2014

(51) Int. Cl. G06F 21/60

(52) U.S. Cl. CPC G06F 21/60

(57) ABSTRACT

Systems and methods for composite code generation for high security transactions and document tracking are disclosed. In one embodiment, a method for conducting a transaction using a composite code may include (1) receiving a transaction request from a user, the transaction request comprising a first composite code; (2) at least one computer processor authenticating the user using a user profile for the user; (3) the at least one computer processor retrieving a transaction that is associated with the first composite code; (4) the at least one computer processor verifying that the transaction is consistent with the user profile; (5) the at least one computer processor receiving a user action for the transaction; and (6) completing the transaction using the user action.

### BACKGROUND OF THE INVENTION

### 1. Field of the Invention

The present invention generally relates to electronic communications, and, more particularly, to systems and methods for composite code generation for high security transactions and document tracking.

### 2. Description of the Related Art

Documents are often shared with meeting participants on their mobile electronic devices, such as tablet computers (e.g., iPad, Samsung Galaxy, etc.), notebook computers, etc. They can be shared, for example, by email, or by RF technology (e.g., Bluetooth, NFC). Currently, there is little control over the documents that are distributed to meeting participants.

### SUMMARY OF THE INVENTION

Systems and methods for composite code generation for high security transactions and document tracking are disclosed.

In one embodiment, a method for composite code generation may include (1) receiving transaction information from a user; (2) at least one computer processor retrieving a user profile; (3) the at least one computer processor generating a composite code that comprises at least a portion of the transaction information and at least a portion of the user profile; and (4) the at least one computer processor associating the composite code with the transaction.

In one embodiment, the method may further include the at least one computer processor authenticating the user.

In one embodiment, the method may further include the at least one computer processor verifying that the transaction is consistent with the user profile.

In one embodiment, the step of verifying that the transaction is consistent with the user profile may include the at least one computer processor comparing the transaction to a history of transactions conducted by the user. In another embodiment, the step of verifying that the transaction is consistent with the user profile may include the at least one computer processor determining that the user is authorized to conduct the transaction.

In one embodiment, the transaction information may include at least a transaction date and a transaction identifier.

In one embodiment, the user profile may include at least one of a user identifier, a user biometric, and a user transaction history.

In one embodiment, the step of associating the composite code with the transaction may include printing the composite code on at least one document associated with the transaction.

In one embodiment, the document may be an electronic document, a tangible (e.g., paper) document, etc.

In another embodiment, the step of associating the composite code with the transaction may include the at least one computer processor storing the transaction with the composite code in a database.

In one embodiment, the composite code may be a machine-readable code.

Methods for tracking a document are disclosed. In one embodiment, a method for tracking a document using composite codes may include (1) receiving, from a user, a first composite code that is associated with a document; (2) at least one computer processor authenticating the user using a user profile; (3) the at least one computer processor accessing the document; (4) the at least one computer processor receiving at least one user action involving the document; (5) the at least one computer processor generating a second composite code based on the at least one action and at least a portion of the user profile; and (6) the at least one computer processor associating the second composite code with the document.

In one embodiment, the step of associating the composite code with the document may include printing the second composite code on the document.

In one embodiment, the document may be an electronic document, a tangible (e.g., paper) document, etc.

In another embodiment, the step of associating the composite code with the transaction may include the at least one computer processor storing the transaction with the composite code in a database.

In one embodiment, the method may further include the at least one computer processor storing the transaction with the code in a database.

In one embodiment, the at least one action may include an edit to the document, an access to the document, etc.

In one embodiment, the method may further include the at least one computer processor disassociating the first composite code from the document.

In one embodiment, the second composite code may be a machine-readable code.

Methods for conducting transactions using composite codes are disclosed. In one embodiment, a method for conducting a transaction using a composite code may include (1) receiving a transaction request from a user, the transaction request comprising a first composite code; (2) at least one computer processor authenticating the user using a user profile for the user; (3) the at least one computer processor retrieving a transaction that is associated with the first composite code; (4) the at least one computer processor verifying that the transaction is consistent with the user profile; (5) the at least one computer processor receiving a user action for the transaction; and (6) completing the transaction using the user action.

In one embodiment, the step of verifying that the transaction is consistent with the user profile may include the at least one computer processor comparing the transaction to a history of transactions conducted by the user.

In another embodiment, the step of verifying that the transaction is consistent with the user profile may include the at least one computer processor determining that the user is authorized to conduct the transaction.

In one embodiment, the step of the at least one computer processor receiving at least one user action for the transaction may include the at least one computer processor retrieving at least one potential user action that is applicable to the transaction; and the at least one computer presenting the at least one potential user action to the user. The user action may be selected from the at least one potential user action.

In one embodiment, the method may further include the at least one computer processor generating a second composite code that comprises at least the action and at least a portion of the user profile; and the at least one computer processor associating the second composite code with the transaction.

In another embodiment, the method may further include the at least one computer processor determining that the user is authorized to take the user action.

In one embodiment, the disclosure may be used with sensitive, confidential or secure documents (e.g., court documents, evidence, mergers and acquisition documents, human resources documents, etc.).

In one embodiment, composite machine-readable codes that may be tracked to the user that creates/writes/reads/edits/accesses the document are disclosed. The code may include, for example, biometric authentication, other transaction, profile and environmental data.

In one embodiment, the codes may include data that can be traced to the biometrics of the user without incorporating actual biometric data of the user.

Machine-readable codes that use biometric authentication are disclosed. The machine-readable codes may be embedded in the document for the lifetime of the document, may be attached as a tag or associated with the document, etc. The machine-readable codes may also be traced to the user who creates/accesses a document. The machine-readable codes may not be trivially decodable by others. The machine-readable codes may be invisible to others, encrypted and conceals the users identity, etc.

In one embodiment, the machine-readable codes may be customized depending on the security level, the document type, etc.

In one embodiment, the machine-readable codes may link the document to a user, a set of users, a transaction, an entry in the back-end system or database, etc.

For example, the link may be used to retrieve information regarding document access privileges, action items, history and profile documents, etc.

In one embodiment, the machine-readable codes may be embedded electronically by, for example, pervasive edits to the document itself, edits to metadata, document tags, etc.

In one embodiment, words and expressions in the document may be replaced with similar words/expressions. For example, each time a document is edited by a user, a natural language processing algorithm alters the text, etc. the changes may be coded numerically as delta functions. Using the delta change, the system may then back-trace document access to the user through, for example, biometric information.

In one embodiment, the machine-readable codes may be graphic, scattered around the text or surrounding areas, based on images, etc. In another embodiment, the machine-readable codes may include a composite biometric that may be generated based on all the accesses to the document, with the weight factors assigned to the latest N accesses or access type pattern/frequencies. In another embodiment, the machine-readable codes may be embedded on physical copies of the document (e.g., paper, tags, magnetic strips, etc.). The machine-readable codes may be embedded on physical copies so as to be invisible to the naked eye, to be read through a reading apparatus (e.g., IR readers, non-visible spectrum light readers, other readers), etc.

In one embodiment, the machine-readable codes may be embedded in the text with visible/invisible text changes, metadata, etc.

In one embodiment, the machine-readable codes may be an invisible code (e.g., a QR code that is not visible to the naked eye). For example, an “invisible” code may be readable with in infrared camera/scanner, ultraviolet light, radio frequencies transmitter/receivers, radiation sensors, etc.

In one embodiment, systems, including for example, processors, customized code writers, etc. that may create, maintain, embed, read, process, etc. a composite code to track the lifetime of the document through every single access, user, action, etc. are disclosed.

In one embodiment, back-end system storage (e.g., a database, etc.) that stores or logs all user accesses to a document is disclosed. The storage may maintain a document edit and access history, document access profile tables, transaction information, critical biometric authentication and marker information and/or links to full profiles, reference data on the document itself and characteristics, etc.

Methods for creating customized codes using, for example, biometric data, transaction profile, environmental data, etc. are disclosed. In one embodiment, the method may include acquiring biometrics and other authentication data from the user. The method may then compare and/or calculate differential functions between the user's reference biometric information and the acquired data can only be known by the server back end. Next, the method may include hashing and performing encryption functions on the data. A composite with data from the document and its characteristics, transaction information, user profile information, session info, history information, environmental data, etc.) may be created. In addition, integrated markers based on the multiple sources may be created. These markers may be hashed and encrypted, and may be stored in one or both of the document and server back end. The resulting composite code may be embedded in the document and linked to the back-end server.

Methods to change the composite code each time with session history information are disclosed. This may particularly relevant for electronic versions of documents. Each document access may change or alter the document code. In one embodiment, biometrics and/or other user profile data may be incorporated with full or partial back traceability to the document.

Method to partially or fully authenticate a user using the composite data and the run-time acquired biometrics, document data (e.g., images, video, etc.) and other data are disclosed. The method may include performing consistency checks with the locally stored data; performing consistency checks at the back-end (in some cases, depending on communication channel availability, security requirements, etc.); acquiring document data at run-time—perform consistency checks with the source document on the server side; matching the end-point user information to the requirements; granting access privileges or denies access accordingly; etc. In one embodiment, mobile devices or specialized readers may be used to scan or acquire any existing data on the document, including electronic documents. The amount of data that is acquired may depend on the security level of the device.

Methods for processing the composite code for direct access to action items to the user are disclosed. In one embodiment, the method may include acquiring biometric and other data from user at use time. The method may provide an action item menu for the given document after authentication that may be based on authentication and document specifics. The method may perform action items in coordination with the user (e.g., refinancing a mortgage by scanning a mortgage document, authenticating the user, and selecting a refinancing options.

Methods to process a composite code using more than one users biometrics and information are disclosed. Multiple biometric sessions on one or more devices may be coordinated, and data may be acquired from the end point and from the server back end.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a system for composite code generation for high security transactions and document tracking according to one embodiment;

FIG. 2 is a flowchart depicting a method for composite code generation for high security transactions and document tracking according to one embodiment;

FIG. 3 is flowchart depicting a method for transaction verification using a composite code according to one embodiment; and

FIG. 4 is flowchart depicting a method for composite code retrieval for high security transactions and document tracking according to one embodiment.

### DETAILED DESCRIPTION OF PREFERRED EMBODIMENTS

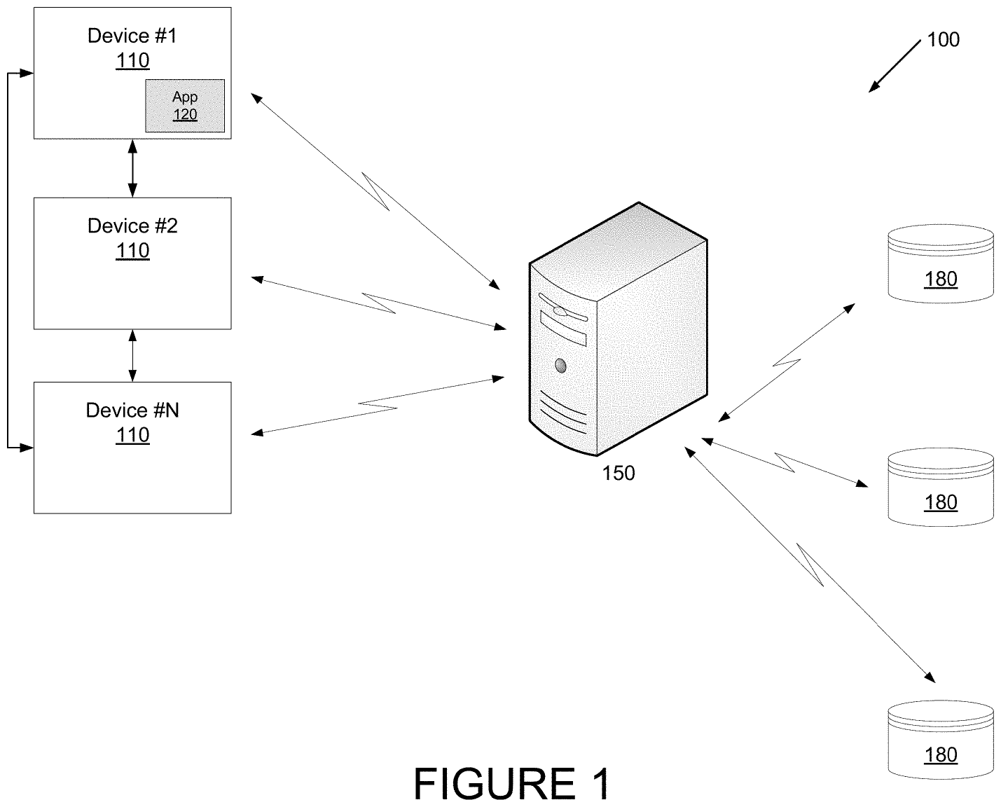

Several embodiments of the present invention and their advantages may be understood by referring to FIGS. 1-4, wherein like reference numerals refer to like elements.

Embodiments of the invention relate to the use of a composite watermark or code that may be printed on a physical document or associated with an electronic document. The watermark/code may be used to trace the document back to a user (e.g., an author, an editor, a person that accesses the document, etc.) and/or trace document lifecycle information (e.g., document author, version information, restrictions, history, transactions, etc.). The watermark/code may be a machine-readable code such as a QR code, an infrared or invisible code, a nanotechnology code, a custom code, a scattered code (e.g., parts of the code are scattered around the document), etc. In one embodiment, the watermark/code may not include actual biometric data, but may instead include markers that may be checked to verify that the user is correctly authenticated.

Although the term “code” may be used throughout this disclosure, it should be recognized that a code may encompass any identifier that may be printed on, affixed to, embedded within, or otherwise associated with a document, object, transaction, etc. regardless of whether the document, object, transaction is tangible or electronic. The “composite code” may integrate several sources of information, such as user data, account data, transaction data, document specifics (e.g., number of pages, hash values, etc.), historical data, user biometric data, etc.). Any type and/or amount of data may be included in the composite code as is necessary and/or desired. In addition, data may be added and/or subtracted to generate a new code as is necessary and/or desired.

In one embodiment, for security, the code may be encrypted, hashed, or otherwise protected.

In one embodiment, the watermark/code may include a link to a server location that may store/maintain document information, biometric information, etc.

When the watermark/code is scanned or read, the document may be linked to a back-end system, such as a server, a group of servers, etc. Each person that scans/enters the watermark/code may be provided with a different level or type of access to the document depending, for example, on the person's position. For example, external parties may be presented with information that has been cleared for their viewing, while internal parties may be presented with customized documents based on position, job requirement, and other access privileges.

Examples of uses for the marking include: tracking the lifecycle of documents; marking sensitive documents; marking documents for electronic notary applications; marking boarding passes so that the biometrics of the user can be checked; marking identification cards and other personal documents (diplomas, loan/mortgage documents, etc.), etc.

An example implementation is as follows. A paper mortgage document may be marked (and printed) with a watermark/code that links to stored biometrics data for the user, as well as the approval chain for the mortgage. When the user presents this document at closing, the user's biometric data may be acquired through an electronic device, and a link to a back-end server is identified from the watermark/code. The acquired biometric data may be checked against the stored biometric data, and the approval chain may be retrieved. Thus, not only is the user biometrically tied to document, but the document cannot be falsified during its lifetime as the documents transaction history, user profile, biometrics, etc. are tied to the watermark/code.

In one embodiment, a separate application may serve as an intermediary between the between the user and the document while not revealing any information through a verification stage. The application may collect biometric data markers from the user and may verify the user or document through the financial institution.

Referring to FIG. 1, a system for composite code generation for high security transactions and document tracking is disclosed. System 100 may include devices 1-N 110, server 150, and database(s) 180. In one embodiment, device 100 may include mobile devices (e.g., mobile phones, smart phones, tablet computers, e-reading devices, etc.), notebook computers, laptop computers, netbook computers, desktop computers, terminals, kiosks (e.g., airline kiosks, automated teller machines, etc.) point of sale devices, etc. Any suitable electronic device may be used as necessary and/or desired.

In one embodiment, device 110 may execute application 120. Application 120 may be a software program, an application, a script, etc.

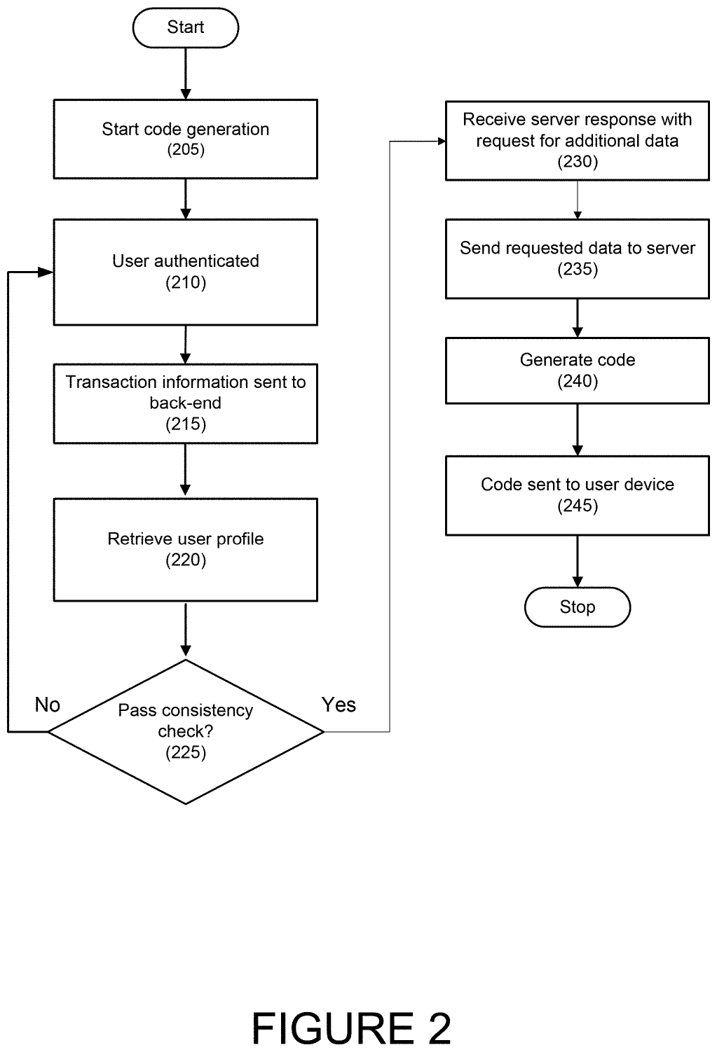

Referring to FIG. 2, a method for composite code generation for transaction and document tracking according to embodiment is disclosed. In step 205, a user may initiate the code generation process. In one embodiment, this may include launching or initiating an application or program, accessing a website, scanning a document, etc. The user may submit the request using an electronic device, including, for example, a mobile electronic device, a notebook computer, a tablet computer, a laptop computer, a desktop computer, a kiosk, a point of sale device, a terminal, etc.

In step 210, the user may be authenticated. In one embodiment, the user may provide biometric data, passwords, codes (e.g., SecureID token code), responses to out of pocket questions, using out of band authentication, etc. Any suitable method for user authentication may be used as necessary and/or desired.

In step 215, the user may provide transaction information. In one embodiment, the user may provide details for a transaction by entering or scanning the data, receiving the data from another device, etc. In one embodiment, the transaction data and the authentication information may be provided to the back-end, such as a server. In one embodiment, the back-end may be located with an entity that may generate a code for the user, such as a financial institution, a government agency, etc.

In step 220, the back-end may retrieve a user profile based on the transaction information, and in step 225, may check the received authentication data against the data in the user profile for consistency. In one embodiment, the user profile may include user account information, user interest information, user transaction history, etc.

For example, if the transaction relates to a mortgage, and the user has no transaction history that indicates that he or she has a mortgage, or is interested in a mortgage, the check may fail and the user may be re-authenticated in step 210. Alternatively, if the consistency check fails, the process may terminate.

In step 230, the back-end may request additional data from the user's device. For example, the back-end may request additional authentication data, additional transaction data, digital certificates on the user device, other security profile on the user device, a history of prior interactions using the user device, the user's recent activity profile, session information, etc.

In step 235, the user may provide the requested data, via the user's electronic device, kiosk, etc. to the back-end. In one embodiment, the user may enter additional transaction data or may provide additional authentication data as necessary and/or desired.

In step 240, the back-end may generate a code. In one embodiment, the code may be a random code. In another embodiment, the code may be a pseudo-random code. In still another embodiment, the code may be based on, or may contain an encrypted version of, one or more of the transaction data, the authentication data, the user profile, document information, user biometric data, environmental variables, random data, data identifying the location, time, etc.

In one embodiment, the code may be a machine-readable code, such as one, two and three dimensional barcodes (e.g., UPC codes, QR codes, etc.), images, symbols, alphanumeric characters, graphics, watermarks, combinations thereof, etc. The codes may be visible or invisible to humans, may be printed with magnetic ink, may be encoded using steganography, etc. The codes may also comprise other digital markers, visual or non-visual markers and embedded meta data/code in the electronic embodiment of the code. The code may also be a collection of minuscule alternations (e.g., imperceptible alterations) to a text that may be translated to a code on the receiving end after processing. Examples of such alterations include changing spaces, characters, words in the text, etc.

In step 245, the back-end may provide the code to the user device. In one embodiment, the code may be printed on, affixed to, or otherwise associated with a document, item, object, transaction, etc. as necessary and/or desired. In one embodiment, the code may be integrated into a single code, or it may be separated into a plurality of parts, etc.

In one embodiment, the code may be associated with the document, item, object, transaction, etc. in a database as is necessary and/or desired.

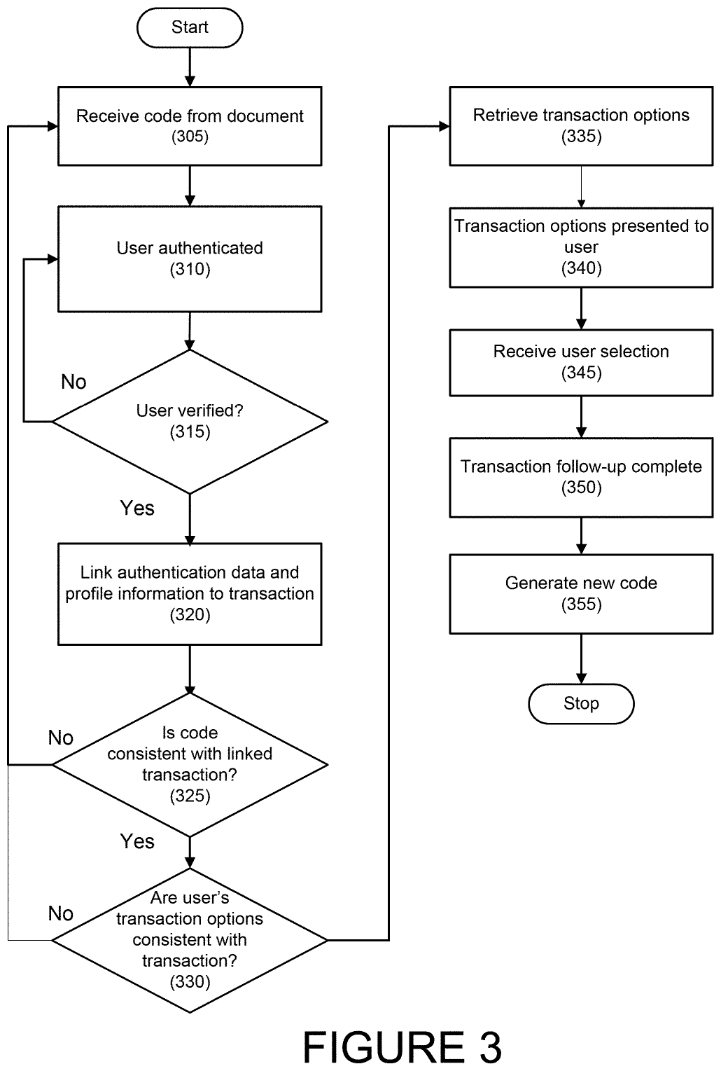

Referring to FIG. 3, a method for transaction verification using a code according to one embodiment is provided.

In step 305, a code from a document may be received. In one embodiment, this code may be received by being scanned, imaged, sensed, entered, etc. In one embodiment, the code may link to an entry that may be stored, maintained and/or accessed by the back-end.

The document may be a paper document, an electronic document, an item, a transaction, an object, etc.

In step 310, the user may be authenticated. In one embodiment, the user may provide biometric data, passwords, codes (e.g., a SecureID token code), responses to out-of-pocket questions, out-of-band authentication, etc. Any suitable method to authenticate the user may be used as necessary and/or desired.

In step 315, the user may be verified to conduct the transaction, access a document, etc. For example, even though the user may be authenticated as him/herself, the user may not have the authorization to conduct the transaction, and may require additional approval (e.g., approval from a supervisor, etc.) to conduct the transaction.

In step 320, the back-end may link the user authentication data and/or user profile information to the transaction. In one embodiment, the back-end is a central part of the initial code generation and later execution stages. Transactions, ay tie in to the back-end authentication and/or user profile from the creation of the code to later authentication/execution stages.

In step 325, the back-end may check to see if the code is consistent with the transaction to which the code is linked. For example, if the transaction is a mortgage document, and the code is linked to a mortgage transaction, the process may continue.

In step 330, the user's transaction options may be checked and/or verified for consistency with the transaction. In one embodiment, the user's transaction option(s) may be specified by the user, and may be checked to see if they are applicable to the transaction.

For example, if the transaction relates to a mortgage, the user may be presented options such as “view your application”, “complete your application”, “view today's rates”, etc. The options may be specific to the type of transaction that is the subject of the verification.

In another embodiment, in step 335, the user's transaction options may be retrieved for the user. In one embodiment, this may involve checking to see if the user has any available action items, lookup the details of those action items, and presenting the details to the user.

In one embodiment, the transaction options may either be pushed (e.g., provided by the user) or pulled (e.g., retrieved from a database) for the user. In another embodiment, a combination of pushing and pulling may be used to present transaction options to the user.

In step 340, the transaction options may be presented to the user.

In step 345, the user's selection of a transaction option may be received.

In step 350, transaction follow-up may be complete. This may involve executing the option selected by the user.

In step 355, the back-end may generate a new code. In one embodiment, the code may be generated as discussed above. The code may be printed on, affixed to, embedded within, or otherwise associated with a document, object, transaction, etc.

In another embodiment, a new code does not need to be generated, and the prior code may be maintained.

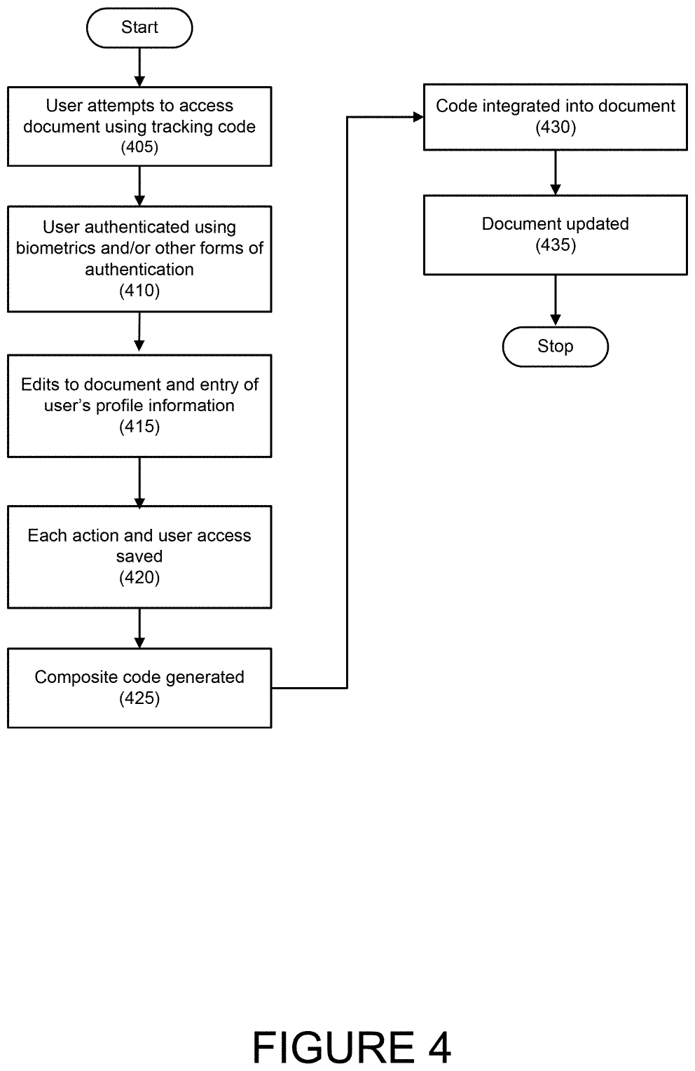

Referring to FIG. 4, a method for document tracking using a code according to one embodiment is provided.

In step 405, a user may attempt to access a document using a code. In one embodiment, the code may be received by being scanned, imaged, sensed, entered, etc. In one embodiment, the code may link to an entry that may be stored, maintained and/or accessed by the back-end.

The document may be a paper document, an electronic document, an item, a transaction, an object, etc.

In step 410, the user may be authenticated. In one embodiment, the user may provide biometric data, passwords, codes (e.g., a SecureID token code), responses to out-of-pocket questions, out-of-band authentication, etc. Any suitable method to authenticate the user may be used as necessary and/or desired.

In step 415, the user may edit the document and may provide the user's profile information. In one embodiment, the user may enter profile information when entering the edits. In another embodiment, the user's profile may be retrieved from the back-end during authentication.

In step 420, user actions and accesses involving the document may be recorded. In one embodiment, general information, such as user X accessed the document on a certain date and at a certain time, and edited the document, may be recorded. In another embodiment, actual edits, such as a track changes log, may be recorded. Any amount of detail regarding the user access and/or edits may be recorded as necessary and/or desired.

In step 425, a composite code, as discussed above, may be generated. In one embodiment, the code may be based on, or may contain an encrypted version of, one or more of the user access data, user edits, the authentication data, the user profile, document information, etc.

In step 430, the code may be integrated into the document. In one embodiment, the code may be printed on, affixed to, integrated into, or otherwise associated with a document (physical or electronic), a transaction, an object, a device, or anything else as is necessary and/or desired. The codes may also comprise other digital markers, visual or non-visual markers and embedded meta data/code in the electronic embodiment of the code. The code may also be a collection of minuscule alternations (e.g., imperceptible alterations) to a text that may be translated to a code on the receiving end after processing. Examples of such alterations include changing spaces, characters, words in the text, etc.

In step 435, the document may be updated and stored.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for generating and associating a composite code with a transaction, comprising;
a server comprising at least one computer processor receiving transaction information for a transaction from an electronic device associated with a user;
the server establishing a session with the electronic device and associating the session with a session identifier;
the server retrieving a user profile for the user comprising a user biometric and at least one of a user identifier and a user transaction history;
the server generating a composite code that comprises at least a portion of the transaction information, at least a portion of the user profile, and the session identifier;
the server embedding the composite code in a document associated with the transaction, wherein the composite code is embedded as a one, two, or three dimensional barcode;
the server receiving the composite code from the one, two, or three dimensional barcode on the document;
the server extracting the at least a portion of the transaction information from the composite code; and
the server causing the at least a portion of the transaction information to be displayed to the user.

2. The method of claim 1, further comprising:
the server authenticating the user.

3. The method of claim 1, further comprising:
the server verifying that the transaction is consistent with the user profile.

4. The method of claim 5, wherein the step of verifying that the transaction is consistent with the user profile comprises:
the server comparing the transaction to a history of transactions conducted by the user.

5. The method of claim 3, wherein the step of verifying that the transaction is consistent with the user profile comprises:
the server determining that the user is authorized to conduct the transaction.

6. The method of claim 1, wherein the transaction information comprises at least a transaction date and a transaction identifier.

7-8. (canceled)

9. The method of claim 1, wherein the document is an electronic document.

10. The method of claim 1, further comprising:
the server associating the transaction with the composite code and storing the association in a database.

11. (canceled)

12. A method for tracking a document, comprising:
receiving, from a user, a first composite code that is embedded in a document as a digital watermark, the first composite code comprising at least a portion of transaction information and at least a portion of a user profile, wherein the user profile includes a user biometric;
a server comprising at least one computer processor extracting the at least a portion of the user profile from the composite code;
the server receiving user identifying information for the user from a user electronic device;
the server authenticating the user using the user profile and the user identification information;
the server establishing a session with the electronic device and associating the session with a session identifier;
the server receiving at least one user action involving the document from the user electronic device;
the server generating a second composite code comprising an identifier for the at least one action, and at least a portion of the user profile, and a session identifier; and
the server embedding the second composite code in the document as a digital watermark.

13. The method of claim 12, wherein the step of embedding the second composite code in the document comprises:
printing the second composite code on the document.

14. The method of claim 13, wherein the document is an electronic document.

15. The method of claim 12, wherein the step of embedding the second composite code in the document comprises:
the server associating the transaction with second composite code and storing the association in a database.

16. The method of claim 12, wherein the at least one action comprises an edit to the document.

17. The method of claim 12, wherein the at least one action comprises an access to the document.

18. The method of claim 12, further comprising:
the server extracting the first composite code from the document.

19-27. (canceled)

28. A method for generating and associating a composite code with a transaction, comprising;
a server comprising at least one computer processor receiving transaction information for a transaction from an electronic device associated with a user;
the server establishing a session with the electronic device and associating the session with a session identifier;
the server retrieving a user profile for the user comprising a user biometric and at least one of a user identifier and a user transaction history;
the server generating a composite code that comprises at least a portion of the transaction information, at least a portion of the user profile, and the session identifier;
the server embedding the composite code in a document associated with the transaction, wherein the composite code is embedded as a digital watermark;
the server receiving the composite code from the digital watermark or the one, two, or three dimensional barcode on the document;
the server extracting the at least a portion of the transaction information from the composite code; and
the server causing the at least a portion of the transaction information to be displayed to the user.
